(19) United States
(12) Patent Application Publication
(10) Pub. No.: US 2012/0154792 A1
(43) Pub. Date: Jun. 21, 2012

(54) Portable system for detecting hazardous agents using SWIR and method for use thereof

(75) Inventors: Patrick J. Treado, Pittsburgh, PA (US); Matthew Nelson, Harrison City, PA (US); Charles W. Gardner, JR., Gibsonia, PA (US); Thomas Voigt, Export, PA (US); Jeffrey Beckstead, Valencia, PA (US)

(73) Assignee: ChemImage Corporation, Pittsburgh, PA (US)

(21) Appl. No.: 13/068,542

(22) Filed: May 12, 2011

Related U.S. Application Data
(60) Provisional application No. 61/395,440, filed on May 13, 2010.

(51) Int. Cl. G01J 3/00

(52) U.S. Cl. 356/51

(57) ABSTRACT

The disclosure provides for a portable device for detecting hazardous agents, including explosives using SWIR hyperspectral imaging. The device may comprise a collection optics, a SWIR multi-conjugate filter, a SWIR camera, and a display. The device may also comprise an RGB camera. The disclosure also provides for a method of using said portable device wherein interacted photons are collected and passed through a SWIR multi-conjugate filter. The interacted photons are detected to generate at least one SWIR hyperspectral image. The SWIR hyperspectral image may be analyzed to determine the presence or absence of a hazardous agent on a target. An RGB image of a target may also be generated and analyzed to survey a sample scene.

### RELATED APPLICATIONS

This application claims priority under 35 U.S.C. §119(e) to U.S. Provisional Patent Application No. 61/395,440, filed on May 13, 2010, entitled “Portable System for Detecting Explosives and Methods for Use Thereof.” This application also claims priority to the following U.S. Provisional patent applications under 35 U.S.C. §119(e): No. 61/465,217, filed on Mar. 16, 2011, entitled “Multi-Conjugate Liquid Crystal Tunable Filters With Square Aperture,” and No. 61/464,432, filed on Mar. 4, 2011, entitled “System And Method For SWIR Hyperspectral Imaging In Low Light Conditions.”

This application is a continuation-in-part of pending U.S. patent application Ser. No. 12/802,649, filed on Jun. 11, 2010, entitled “Portable System for Detecting Explosives and Method for Use Thereof,” which itself claims priority under 35 U.S.C. §119(e) to U.S. Provisional Patent Application No. 61/278,393, filed on Oct. 6, 2009, entitled “Use of magnification to increase SWIR HSI detection sensitivity.” This application is also a continuation-in-part of the following pending U.S. patent applications: Ser. No. 12/899,119, filed on Oct. 6, 2010, entitled “System and Method for Combined Raman, SWIR and LIES Detection,” Ser. No. 12/924,831, filed on Oct. 6, 2010, entitled “System and Methods for Explosives Detection using SWIR,” Ser. No. 13/020,935, filed on Feb. 4, 2011, entitled “System and Method for Detecting Hazardous Agents Including Explosives,” Ser. No. 13/020,944, filed on Feb. 4, 2011, entitled “System and Method for Detection of Explosive Agents Using SWIR and MWIR Hyperspectral Imaging,” Ser. No. 12/754,229, filed on Apr. 5, 2010, entitled “Chemical Imaging Explosives (CHIMED) Optical Sensor,” and Ser. No. 13/020,997, filed on Feb. 4, 2011, entitled “System and Method for Detection of Explosive Agents Using SWIR, MWIR and LWIR Hyperspectral Imaging.”

Each of the above referenced applications is hereby incorporated by reference in their entireties.

### BACKGROUND

Spectroscopic imaging combines digital imaging and molecular spectroscopy techniques, which can include Raman scattering, fluorescence, photoluminescence, ultraviolet, visible and infrared absorption spectroscopy. When applied to the chemical analysis of materials, spectroscopic imaging is commonly referred to as chemical imaging.

Instruments for performing spectroscopic (i.e. chemical) imaging typically comprise an illumination source, image gathering optics, focal plane array imaging detectors and imaging spectrometers. In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF) or a liquid crystal tunable filter (“LCTF”). Here, the organic material in such optical filters is actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

There currently exists a need to enhance a warfighter's capability to detect surface chemicals and explosives, explosive residue, and other hazardous and non-hazardous materials. There also exists a need to enhance warfighters' capability for dismounted situational awareness to rapidly detect in a noncontact, standoff mode the presence of surface chemicals and explosives residue within their environment. It would be advantageous if a portable and/or handheld device could be configured to provide rapid, accurate analysis of target materials present in a scene. It would also be advantageous if such a device could be configured to provide for On-the-Move (“OTM”) detection.

### SUMMARY OF THE INVENTION

The present disclosure provides for a portable device and method for detecting explosives and other materials using short wave infrared (“SWIR”) spectroscopic imaging. Spectroscopic imaging may include multispectral or hyperspectral imaging (“HSI”). HSI combines high resolution imaging with the power of massively parallel spectroscopy to deliver images having contrast that define the composition, structure, and concentration of a sample. HSI records an image and a fully resolved spectrum unique to the material for each pixel location in the image. Utilizing a liquid crystal imaging spectrometer, SWIR images are collected as a function of wavelength, resulting in a hyperspectral datacube where contrast is indicative of the varying amounts of absorbance, reflectance, scatter, or emission associated with the various materials present in the field of view (“FOV”). The hyperspectral datacube may be composed of a single spectroscopic method or a fusion of complimentary techniques.

The system and method of the present disclosure overcome the limitations of the prior art by providing for a portable SWIR sensor for rapid, wide area, noncontact, nondestructive detection of hazardous agents, including but not limited to, explosives and explosive and chemical residues in complex environments. The invention of the present disclosure is also advantageous over the prior art due to is implementation of an integrated filter. This integrated filter may be configured with a trigger mechanism, which holds potential for communication between various filter components.

The system and method of the present disclosure may also be used to detect explosive materials on surfaces such as metal, sand, concrete, skin, shoes, people, clothing, vehicles, baggage, entryways, concealments, and others. The system and method of the present disclosure hold potential for meeting the needs of warfighters to interrogate suspect vehicles, suspect individuals or suspect facilities in a standoff, wide area surveillance and covert manner. The portable device may be configured in a handheld embodiment, which may be carried by a warfighter as they move throughout a sample scene. The portable device may also be configured for mounting on a vehicle or other apparatus for either stationary or dynamic operation. It is also contemplated by the present disclosure that the portable device may be configured to operate in an OTM configuration, providing accurate detection of target materials while in motion.

The present disclosure contemplates the use of miniaturized components (optics, detector and filter) that will not compromise sensitivity or selectivity and that will still provide high probability of detection (“P_{D}”) and low false alarm rate (“FAR”), consistent with our full-size platform-mounted/vehicle-mounted sensors.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

The patent or application file contains at least one drawing executed in color. Copies of this patent or patent application publication with color drawing(s) will be provided by the Office upon request and payment of the necessary fee.

FIG. 1 is illustrative of exemplary packaging of an embodiment of the portable device of the present disclosure.

FIG. 2A is a schematic of exemplary components of a portable device of the present disclosure.

FIG. 2B is a schematic of exemplary components of a portable device of the present disclosure.

FIG. 3 is an illustrative overview of a multi-conjugate tunable filter.

FIG. 4A is illustrative of exemplary packaging of a filter that may be incorporated into a portable device of the present disclosure.

FIG. 4B is a schematic of exemplary components of an integrated filter.

FIG. 4C is a schematic of exemplary components of an integrated filter.

FIG. 4D is illustrative of the potential “dark” region associated with the combination of a square camera and circular filter.

FIG. 5 is representative of a method of the present disclosure.

FIG. 6 illustrates the detection capabilities of a device of the present disclosure.

FIG. 7 illustrates a comparison of the detection capabilities of a portable device of the present disclosure and a full-sized sensor system.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts.

The present disclosure provides for a portable device and method for use there of which may be used to detect hazardous agents, such as explosives, explosive residues, and explosive binder materials, among others. In one embodiment, the present disclosure provides for a portable device for detecting hazardous agents using SWIR hyperspectral imaging.

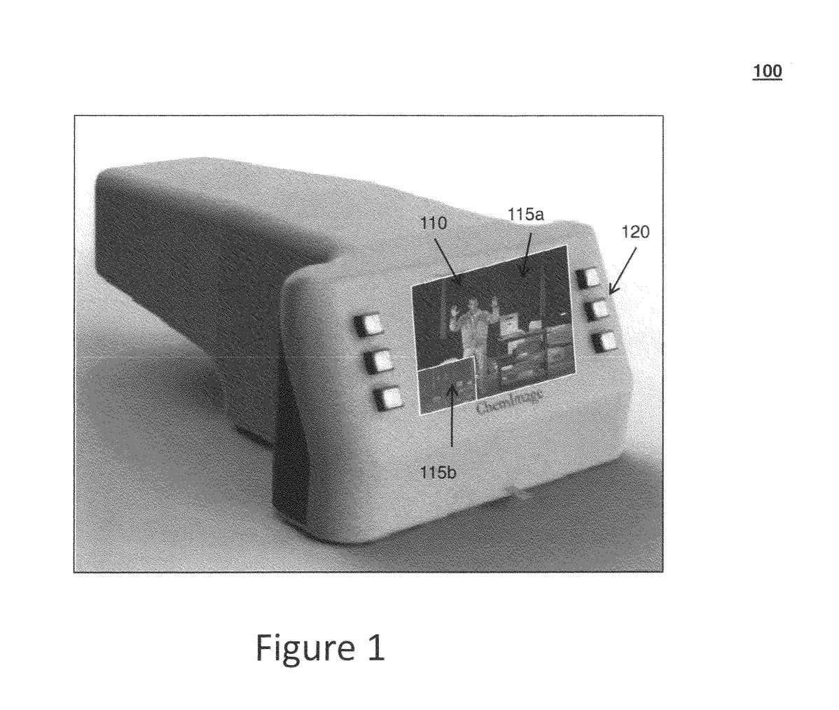

FIG. 1 is illustrative of exemplary packaging of a portable device 100 provided for by the present disclosure. The device 100 may comprise a display 110 for displaying a short wave infrared image. In another embodiment, this display may display other user functions and/or control features for operating the device 100. This display 110 may display a result including at least one of: an image, a spectrum, a text message, a working indication, or other information that can be used to identify the target material. In one embodiment, the visual indicator may be complemented by an audio warning signal or other identification means. In another embodiment, the display screen may be configured to display more than one image at a time. In one embodiment, a video image may be provided along with a SWIR spectroscopic image and/or a dynamic image.

The display 110 may be configured, in an embodiment illustrated by FIG. 1, to provide for simultaneous display of two or more images. FIG. 1 illustrates the simultaneous display of image 115a and 115b. These images may acquired using the same modality or may be acquired using two or more different modalities. Such configuration holds potential for reducing false alarm rates by enabling rapid confirmation of suspect threats. In another embodiment, consecutive display of multiple images may be used. Controls 120 may be used to operate the device 100.

The portable device 100 is illustrated in FIG. 1 as a handheld device. However, the present disclosure contemplates that other configurations may be implemented depending on the users specifications. In one embodiment, the portable device may be configured for mount on a vehicle. In another embodiment, the portable device may be configured for mounting on a stationary apparatus.

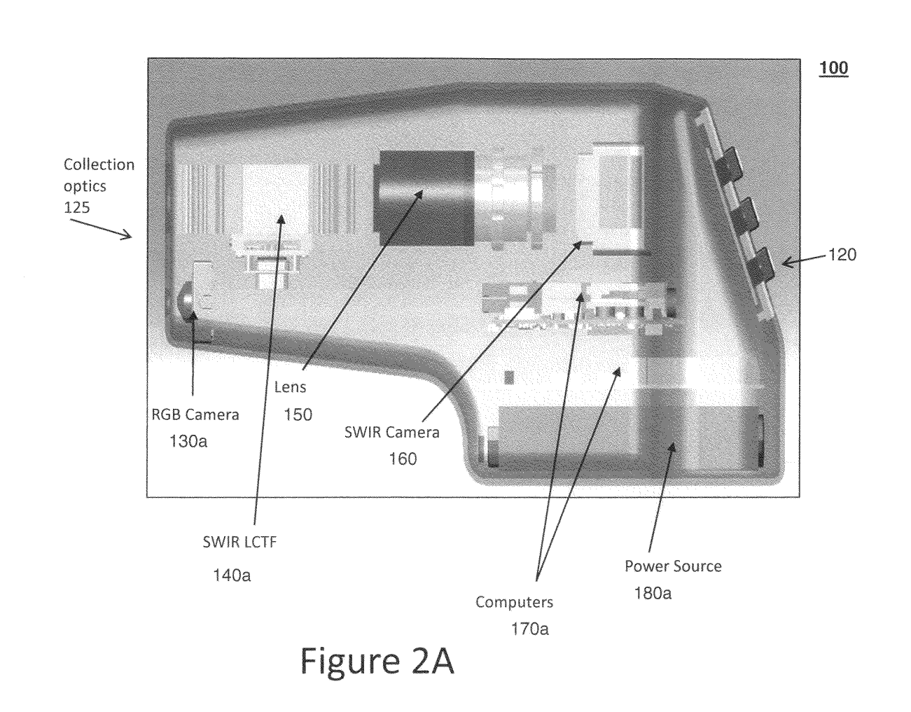

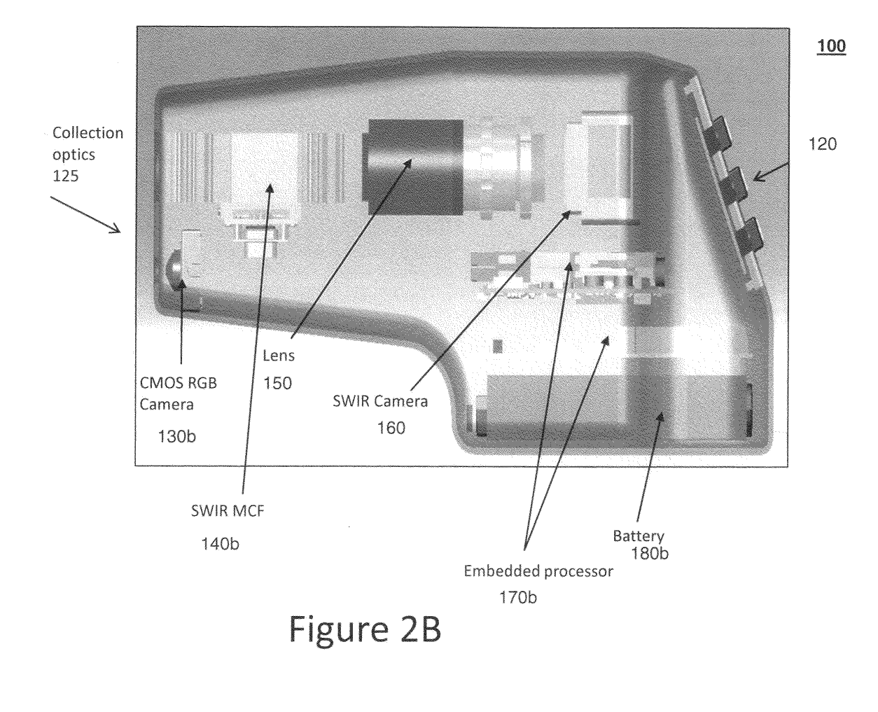

FIG. 2A is representative of the various components of the portable device 100. In one embodiment, the portable device 100 may comprise at least one collection optics 125. This collection optics 125 may be configured so as to collect a plurality of interacted photons. These interacted photons may be generated by illuminating at least a portion of a target. In one embodiment, this illumination may comprise passive illumination. Such a configuration may utilize solar radiation as an illumination source. This target may be a variety of objects including but not limited to: a human, a body part, an animal, a building, a vehicle, a document, vegetation, a roadway, concrete, foam, metal, plastic, clothing, luggage, and combinations thereof. The system and method hold potential for application in a variety of settings including but not limited to: for interrogation of suspect vehicles (at a checkpoint, parked along the roadway or traveling freely); interrogation of suspect facilities wherein homemade explosive production or IED assembly may be taking place; and interrogation of suspect individuals (at a checkpoint or an unstructured crowd). The present invention holds potential for accurately detecting explosives and explosive residue in a sample scene comprising a number of materials including emplacements, urban clutter, ordnance and/or explosive residue. The present disclosure also holds potential for the detection of command wires, disturbed earth, and pressure plates that may be present in a sample scene.

In one embodiment, the plurality of interacted photons may be passed through a tunable filter. In one embodiment, the tunable filter may comprise a multi-conjugate tunable filter. The multi-conjugate tunable filter is a type of liquid crystal tunable filter (“LCTF”) which consists of a series of stages composed of polarizers, retarders, and liquid crystals. The multi-conjugate tunable filter is capable of providing diffraction limited spatial resolution, and a spectral resolution consistent with a single stage dispersive monochromator. The multi-conjugate tunable filter may be computer controlled, with no moving parts, and may be tuned to any wavelength in the given filter range. This results in the availability of hundreds of spectral bands. In one embodiment, the individual liquid crystal stages are tuned electronically and the final output is the convolved response of the individual stages. The multi-conjugate tunable filter holds potential for higher optical throughput, superior out-of-band rejection and faster tuning speeds. In one embodiment, this tunable filter may be selected from the group consisting of: a Fabry Perot angle tuned filter, an acousto-optic tunable filter, a liquid crystal tunable filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, a liquid crystal Fabry Perot tunable filter, and a multi-conjugate tunable filter, and combinations thereof.

In one embodiment, this tunable filter may comprise filter technology available from ChemImage Corporation, Pittsburgh, Pa. This technology is more fully described in the following U.S. patents and patent applications: U.S. Pat. No. 6,992,809, filed on Jan. 31, 2006, entitled “Multi-Conjugate Liquid Crystal Tunable Filter,” U.S. Pat. No. 7,362,489, filed on Apr. 22, 2008, entitled “Multi-Conjugate Liquid Crystal Tunable Filter,” Ser. No. 13/066,428, filed on Apr. 14, 2011, entitled “Short wave infrared multi-conjugate liquid crystal tunable filter.” These patents and patent applications are hereby incorporated by reference in their entireties.

This tunable filter may be a SWIR liquid crystal tunable filter 140a, as illustrated in FIG. 2A. This tunable filter may be configured so as to sequentially filter the plurality of interacted photons into a plurality of predetermined wavelength bands. The filter may comprise an optical filter configured so as to operate in the short-wave infrared range of approximately 850-1700 nm.

These filtered photons may then, in one embodiment, pass through lens 150. The portable device 100 may further comprise one or more detectors for detecting a plurality of interacted photons. In one embodiment, illustrated by FIG. 2A, one detector may comprise a SWIR camera 160. This SWIR camera 160 may be configured to detect the plurality of interacted photons and generate a SWIR data set representative of the target under interrogation. In one embodiment, the focal plane array detector may comprise an uncooled InGaAs focal plane array detector.

In one embodiment, this SWIR data set may comprise at least one SWIR hyperspectral image which can be displayed on the display 120. A hyperspectral image comprises an image and a fully resolved spectrum unique to the material for each pixel location in the image. In one embodiment, the spectroscopic image is a spatially accurate wavelength resolved image. In one embodiment, this first detector may comprise a focal plane array detector. In another embodiment, this first detector may comprise at least one of: an InGaAs focal plane array detector, an InSb focal plane array detector, a MCT focal plane array detector, and combinations thereof. In another embodiment, an OEM modules may be implemented rather than a full size camera module.

In one embodiment, the portable device 100 may further comprise a second detector. The embodiment illustrated by FIG. 2A illustrates this second detector may comprise a RGB camera 130a. This RGB camera 130a may be configured to generate a RGB image of a target. This RGB camera 130a may also be configured to generate an RGB image of a sample scene. Such an image may be inspected by a user to locate an area of interest in the sample scene for further interrogation using SWIR. Therefore, in one embodiment this RGB modality may be used for targeting and a SWIR modality may be used for identification of the presence or absence of a hazardous agent. The RGB images generated by the portable device 100 may comprise RGB video images.

The portable device 100 may also comprise one or more computers 170a that may be configured for operation of the portable device 100. The computers 170a may also be configured to store data collected during operation and/or reference libraries. These reference libraries may comprise reference SWIR data that may be consulted to determine the presence or absence of a hazardous agent on a target. In one embodiment, these reference images and reference spectra may be stored in the memory of the device itself. In another embodiment, the device may also be configured for remote communication with a host station using a wireless link to report important findings or update its reference library. A power source 180a may provide for operation.

FIG. 2B is illustrative of another embodiment of a portable device 100. In this embodiment, the portable device may comprise components similar to those in FIG. 2A. The RGB camera 130a in FIG. 2A may comprise a CMOS RGB camera 130b in the embodiment of FIG. 2B. The SWIR LCTF 140a of FIG. 2A may comprise a SWIR MCF 140b in the embodiment of FIG. 2B. The SWIR MCF holds potential for providing for high transmission while maintaining an excellent out-of-band rejection ratio. The advantages of the SWIR MCF may also include fast tuning speed and high accuracy.

The computer 170a of FIG. 2A may comprise one or more embedded processors 170b in the embodiment of FIG. 2B. Embedded processor technology holds potential for real-time processing and decision-making. The use of a MCF and embedded processor technology holds potential for achieving faster wavelength switching, image capture, image processing and explosives detection. The power source 180a in FIG. 2A may comprise at least one battery 180b in FIG. 2B.

In another embodiment, the portable device 100 may further comprise an active illumination source. This active illumination source may comprise a laser illumination source, a broadband light source, or other light source known in the art that may be configured for SWIR interrogation of a target.

In one embodiment, the device 100 may further comprise one or more communication ports for electronically communicating with other electronic equipments such as a server or printer. In one embodiment, such communication may be used to communicate with a reference database or library comprising at least one of: a reference spectra corresponding to a known material and a reference short wave infrared spectroscopic image representative of a known material. In such an embodiment, the device may be configured for remote communication with a host station using a wireless link to report important findings or update its reference library.

The present disclosure contemplates a quick analysis time, measured in terms of seconds. For example, various embodiments may contemplate analysis time in the order of <10 seconds, <5 seconds, and <2 seconds. Therefore, the present disclosure contemplates substantially simultaneous acquisition and analysis of spectroscopic images. In one embodiment, the sensor may be configured to operate at speeds of up to 15-20 mph. One method for dynamic chemical imaging is more fully described in U.S. Pat. No. 7,046,359, filed on Jun. 30, 2004, entitled “System and Method for Dynamic Chemical Imaging”, which is hereby incorporated by reference in its entirety.

The device 100 may comprise embedded system parallel processor technology for real-time processing and decision-making that may be implemented in a device of the present disclosure. In one embodiment, this embedded processor technology may comprise Hyper-X embedded processor technology.

In one embodiment of the present disclosure, the portable device comprises a lens suitable for use in a portable device. The use of a smaller lens (as opposed to a telescope lens that may be found in a larger system) allows for the system's small size. In one embodiment, the device may comprise a fixed focal length optic. The present disclosure also contemplates the use of a smaller camera format (in one embodiment a smaller sized 640×512 pixel camera). The present disclosure also contemplates the use of an embedded processor to reduce the size of the computer and increase speed.

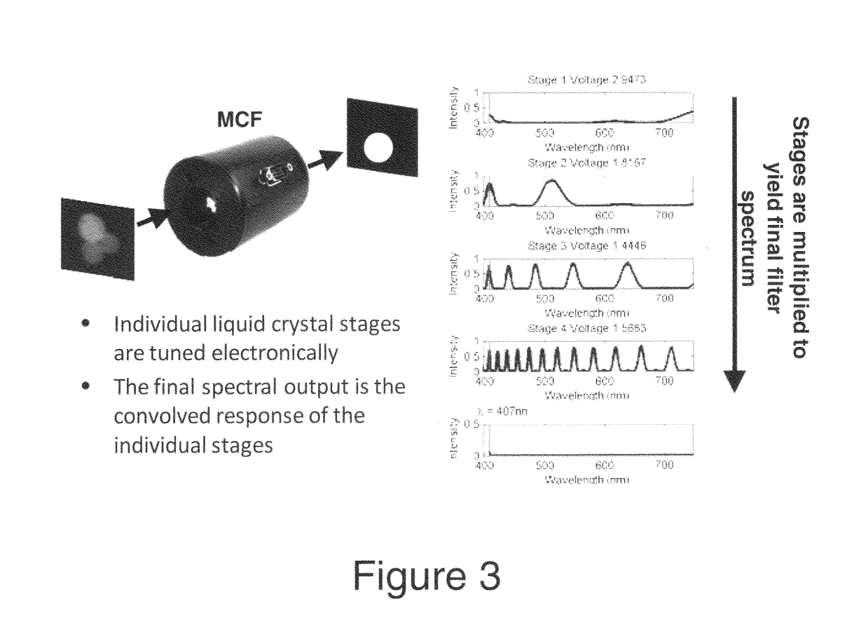

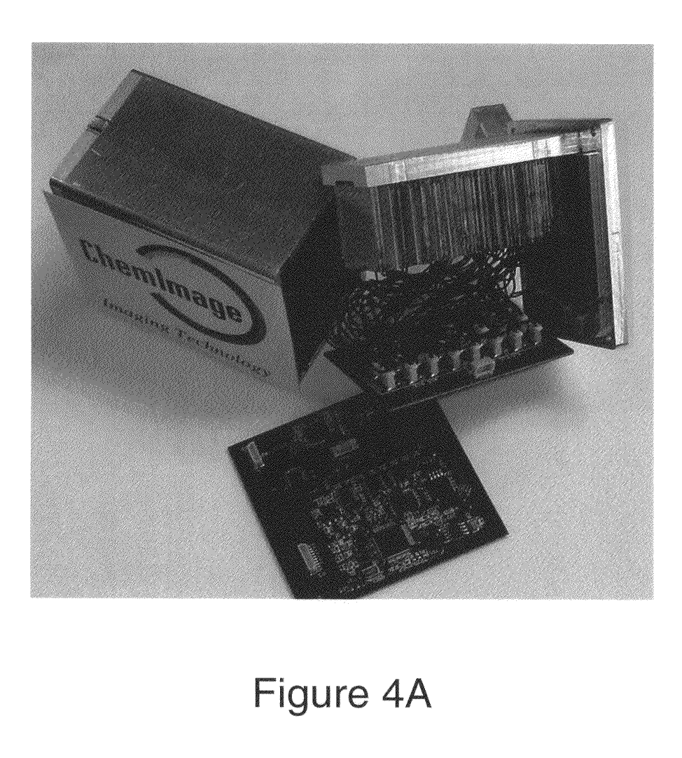

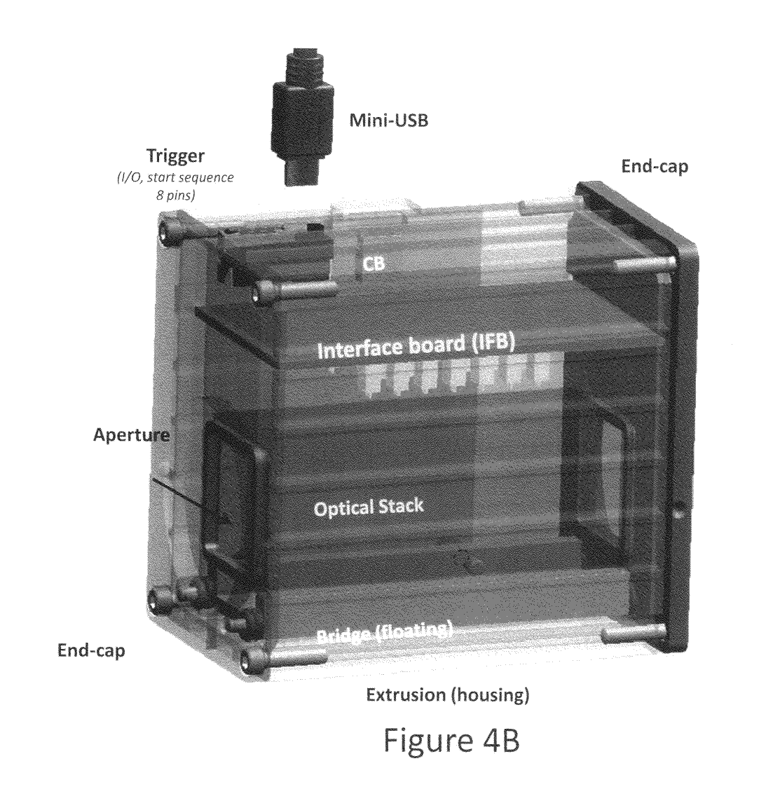

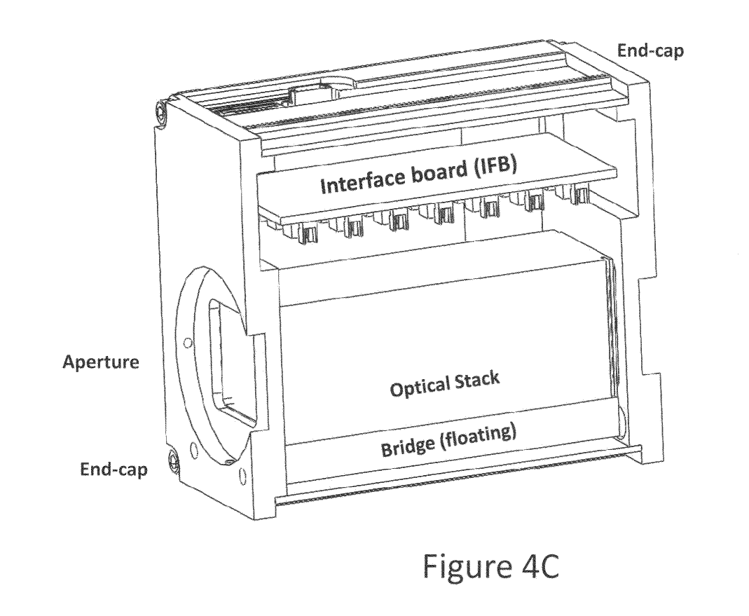

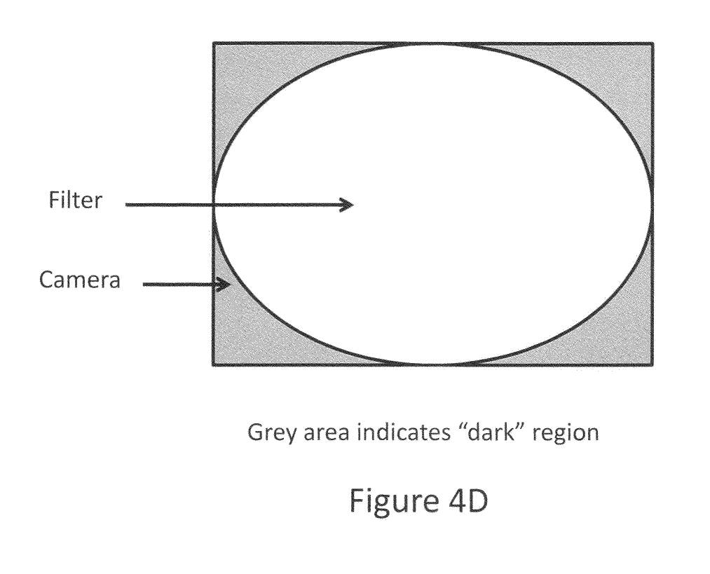

FIG. 3 is provided to illustrate an overview of a multi-conjugate filter. FIG. 4A is illustrative of exemplary housing of a filter that may be incorporated into the portable device 100. In one embodiment, this multi-conjugate filter may be configured with an integrated design. An exemplary schematic of such an integrated filter is illustrated in FIGS. 4B and 4C. Such filters hold potential for increasing image quality, reducing system size, and reducing manufacturing cost. Such a design may enable integration of a filter, a camera, an optic, a communication means, and combinations thereof into an intelligent unit. This design may also comprise a trigger system configured to increase speed and sensitivity of the system. In one embodiment, this trigger may comprise a trigger TTL. The trigger may be configured so as to communicate a signal when various components are ready for data acquisition. The trigger may be configured to communicate with system components so that data is acquired at a number of sequential wavelengths. Such a design may hold potential for reducing noise. This integration may enable communication between the elements (optics, camera, filter, etc.). This communication may be between a filter and a camera, indicating to a camera when a filter ready for data acquisition.

In one embodiment, the filter may be configured with a square aperture. This square aperture configuration holds potential for overcoming the limitations of the prior art by increasing image quality and reducing system size and manufacturing costs. Such an embodiment enables the configuration of such filters to fit almost exactly on a camera, such as a CCD. This design overcomes the limitations of the prior art by providing a much better fit between a filter and a camera. This better fit may hold potential for utilizing the full CCD area, optimizing the field of view. This configuration holds potential for an optimized design wherein every pixel may have the same characteristic and enabling a high density image.

The problems associated with the prior art are illustrated in FIG. 4D. As can be seen in the Figure, the camera and filter do not exactly line up, creating “dark” areas in the corners. This results in lower image quality than is possible utilizing the configuration of the present disclosure.

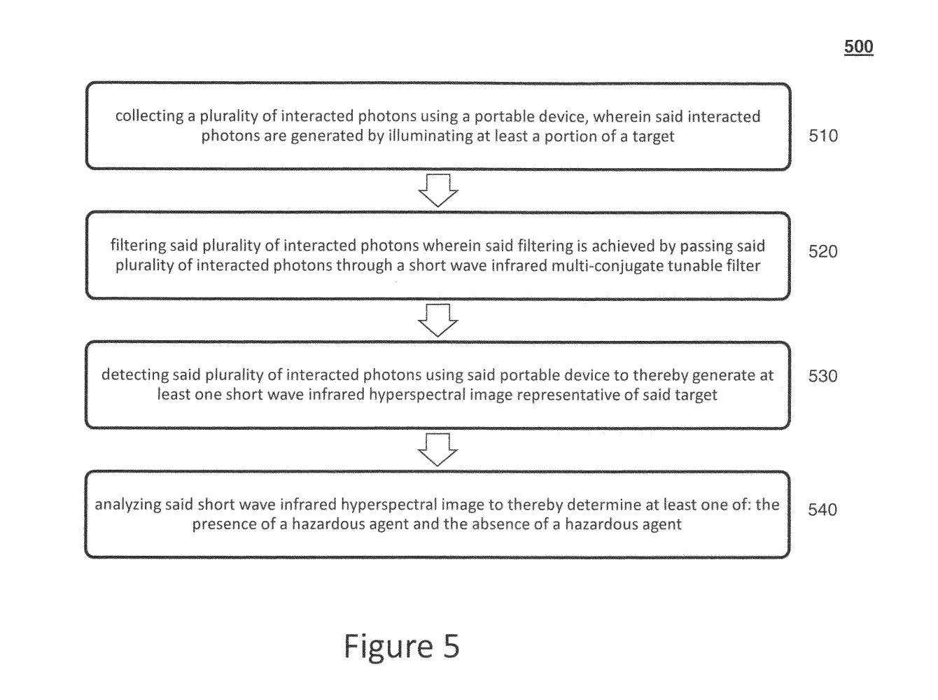

The present disclosure also provides for a method for detection hazardous agents, including explosives and explosives residues. One embodiment of a method of the present disclosure is illustrated in FIG. 5. In one embodiment, the method 500 may comprise collecting a plurality of interacted photons using a portable device in step 510. This plurality of interacted photons may be generated by illuminating at least a portion of a target under interrogation.

In one embodiment, this plurality of interacted photons be selected from the group consisting of: photons reflected by the target, photons absorbed by the target, photons scattered by the target, photons emitted by the target and combinations thereof. In one embodiment, this plurality of interacted photons may be generated by illuminating the target. This illumination may be accomplished using passive illumination, active illumination, and combinations thereof. In an embodiment implementing passive illumination, solar illumination may be used as an illumination source. In an embodiment implementing active illumination, a laser or other light source may be used to illuminate the target.

In step 520 the plurality of interacted photons may be filtered by passing the plurality of interacted photons through a tunable filter. In one embodiment, this filter may comprise a SWIR MCF. This SWIR MCF may be configured so as to sequentially filter the plurality of interacted photons into a plurality of predetermined wavelength bands.

In step 530, the plurality of interacted photons may be detected using said portable device to thereby generate at least one SWIR hyperspectral image representative of the target. In one embodiment, this SWIR hyperspectral image may be displayed to a user on a portable device's display. In one embodiment, this displaying may further comprise associating at least one pseudo color with a hazardous agent. In one embodiment, a pseudo color may be assigned to indicate the presence of a hazardous agent. In another embodiment, a pseudo color may be assigned to indicate the absence of a hazardous agent. In one embodiment, two or more pseudo colors may be used to correspond to two or more different materials in said hyperspectral image.

In one embodiment, the use of pseudo colors may comprise technology available from Chemlmage Corporation, Pittsburgh, Pa. This technology is more fully described in pending U.S. Patent Application Publication No. US20110012916, filed on Apr. 20, 2010, entitled “System and method for component discrimination enhancement based on multispectral addition imaging,” which is hereby incorporated by reference in its entirety.

This SWIR hyperspectral image may be analyzed in step 540 to thereby determine at least one of the presence of a hazardous agent on the target and the absence of a hazardous agent on the target. As discussed, this hazardous agent may comprise an explosive agent, an explosive residue, or other material associated with the manufacture and/or use of explosives. In another embodiment, the hazardous agent may comprise a biological agent, a chemical agent, and combinations thereof.

In one embodiment, analyzing 540 may comprise comparing said SWIR hyperspectral image with at least one reference image, wherein the reference image corresponds to a known material. In one embodiment, this reference image may be one image in a reference database comprising a plurality of reference images. The present disclosure also contemplates that at least one SWIR spectrum representative of the target may also be analyzed and compared to at least one SWIR reference spectrum a reference database.

In one embodiment, this comparing may be achieved by applying one or more chemometric techniques to at least one of a SWIR hyperspectral image representative of a target, a SWIR spectrum representative of a target, and combinations thereof. In one embodiment, this technique may be any known in the art, including but not limited to: principle component analysis (“PCA”), partial least squares discriminate analysis (“PLSDA”), cosine correlation analysis (“CCA”), Euclidian distance analysis (“EDA”), k-means clustering, multivariate curve resolution (“MCR”), band t. entropy method (“BTEM”), mahalanobis distance (“MD”), adaptive subspace detector (“ASD”), spectral mixture resolution, and combinations thereof. In another embodiment, pattern recognition algorithms may be used.

In one embodiment, the method 500 may be automated using software. In one embodiment, the invention of the present disclosure may utilize machine readable program code which may contain executable program instructions. A processor may be configured to execute the machine readable program code so as to perform the methods of the present disclosure. In one embodiment, the program code may contain the Chemlmage Xpert® software marketed by Chemlmage Corporation of Pittsburgh, Pa. The Chemlmage Xpert® software may be used to process image and/or spectroscopic data and information received from the portable device of the present disclosure to obtain various spectral plots and images, and to also carry out various multivariate image analysis methods discussed herein.

In one embodiment, the method 500 may further comprise generating at least one RGB image representative of a target. In another embodiment, a RGB image representative of a sample scene comprising a target may be generated. The present disclosure also contemplates that an area of interest of a target may be assessed using RGB imaging. In one embodiment, the RGB image generated may comprise a RGB video image.

In one embodiment, the method 500 may further comprise generating an RGB image of a sample scene and/or target to scan an area for suspected hazardous agents (a targeting mode). A target can then be selected based on size, shape, color, or other feature, for further interrogation. This target may then be interrogated using SWIR for determination of the presence or absence of a hazardous agent. In such an embodiment, a RGB image and a SWIR hyperspectral image may be displayed consecutively. In one embodiment, the SWIR hyperspectral image and the RGB image may be displayed simultaneously. This may enable rapid scan and detection of hazardous agents in sample scenes.

In one embodiment, data acquired using two or more modalities may be fused. In one embodiment, SWIR data may be fused with RGB data to increase accuracy and reliability of detection. In one embodiment, this fusion may be accomplished using Bayesian fusion. In another embodiment, this fusion may be accomplished using technology available from Chemlmage Corporation, Pittsburgh, Pa. This technology is more fully described in the following pending U.S. patent applications: No. US2009/0163369, filed on Dec. 19, 2008 entitled “Detection of Pathogenic Microorganisms Using Fused Sensor Data,” Ser. No. 13/081,992, filed on Apr. 7, 2011, entitled “Detection of Pathogenic Microorganisms Using Fused Sensor Raman, SWIR and LIBS Sensor Data,” No. US2009/0012723, filed on Aug. 22, 2008, entitled “Adaptive Method for Outlier Detection and Spectral Library Augmentation,” No. US2007/0192035, filed on Jun. 9, 2006, “Forensic Integrated Search Technology,” and No. US2008/0300826, filed on Jan. 22, 2008, entitled “Forensic Integrated Search Technology With Instrument Weight Factor Determination.” These applications are hereby incorporated by reference in their entireties.

In another embodiment, the method may comprise: illuminating at least a portion of a target material with illuminating photons emanating from a portable device to thereby generate interacted photons wherein said interacted photons are selected from the group consisting of: photons absorbed by the sample, photons reflected by the sample, photons emitted by the sample, photons scattered by the sample, and combinations thereof; forming a short wave infrared image of at least a portion of said target material using said interacted photons; analyzing said short wave infrared hyperspectral image using said portable device to thereby classify at least a portion of said target material as comprising at least one of: an explosive material, a concealment material, a non-explosive material, and combinations thereof.

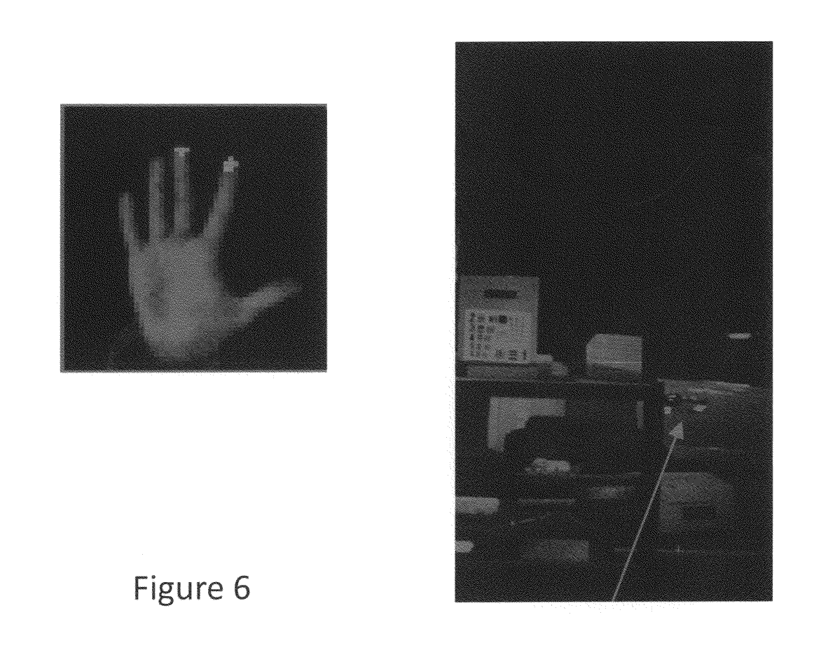

FIG. 6 illustrates standoff detection using CONDOR-ST, Gen 2 technology. As illustrated, the device of the present disclosure holds potential for detecting explosives residue on surfaces such as human skin and car doors. In one embodiment contemplated by the present disclosure, this range may comprise approximately 20 meters.

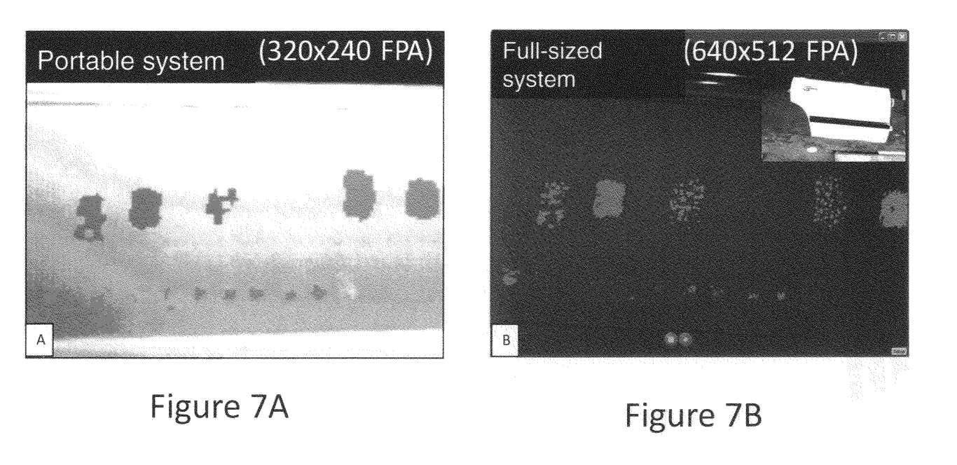

FIGS. 7A and 7B are provided to compare the performance of the portable device of the present disclosure (FIG. 7A) with a full-sized system (FIG. 7B). Both systems were able to accurately detect Ammonium Nitrate (red) and Urea residue (green). Therefore, the portable device described herein holds potential for performing as well as a full-sized system.

In one embodiment, the present disclosure may implement CONDOR-ST technology, available from Chemlmage Corporation, Pittsburgh, Pa. This technology maybe referred to commercially in a handheld configuration as “Roadrunner.”

In one embodiment of the present disclosure, SWIR hyperspectral imaging may be achieved using a sensor mounted to a vehicle for OTM detection. In another embodiment, the sensor may be mounted to a platform for stationary surveillance and detection. This embodiment provides for standoff detection and may be used in EOD, route clearance, tactical and convoy operations. In one embodiment, the device may be configured to provide detection performance at ranges of up to 20 m standoff distance, which includes high probability of detection (P_{D}) and low false alarm rate (FAR). The system may operate traveling at speeds of up to 45 mph, for screening frequently traveled routes or villages.

This sensor is sometimes referred to commercially as the “LG-2 sensor” or the “LightGuard sensor” or the “LightGuard 2 sensor” or the “NightGuard sensor.” This technology may combine a SWIR MCF with a zoom optic for viewing a large area, or imaging a localized are at high magnification and incorporates. The LG-2 sensor also utilizes a high definition RGB sensor. Previous generations of the SWIR HSI sensors contained an LCTF and a fixed focal length optic, requiring one sensor for wide-area surveillance and a second sensor for local confirmation. The Hyper-X embedded processor is also an important upgrade to this new generation sensor. For detection and identification of disturbed earth, spatially-resolved SWIR spectral signatures are compared to a SWIR spectral library that is compiled from known material signatures and trained against ambient background. Positive detection may be obtained by comparing the measured spectra to signature libraries using pattern matching algorithms implemented in a simple user interface.

This technology is more fully described in the following pending U.S. patent applications, hereby incorporated by reference in their entireties: No. US2011/0089323, filed on Oct. 6, 2010, entitled “System and Methods for Explosives Detection Using SWIR,” and Ser. No. 13/020,935, filed on Feb. 4, 2011, entitled “System and Method for Detecting Hazardous Agents Including Explosives.”

The following Tables show non-exclusive and exemplary specifications for embodiments of the portable device of the present disclosure.

TABLE 1

| Performance Parameter | Specification |
|---|---|
| Sensing modality | SWIR(900-1700 nm at 8 nm bandpass) |
| | hyperspectral imaging spectroscopy |
| Types of targets | Chemicals and explosives on surfaces (i.e., |
| | metal, sand, concrete, skin, etc.) |
| Time to detect | <2 seconds depending on target type, |
| | concentration, and operation conditions |
| Detection range | 20 m |
| Size | Est. 6″ wide × 5″ high × 10″ long |
| Weight | Est. <5 lbs |
| Power required | 100 watts |
| Maturity | TRL 6+ |
| Safety issues | None, passive sensor, eye safe, radiation safe |

TABLE 2

| Performance Parameter | Specification |
|---|---|
| Sensing modality | SWIR(900-1700 nm at 8 nm bandpass) |
| | hyperspectral imaging spectroscopy |
| Types of targets | Disturbed earth, IED camo, explosives on |
| | surfaces, command wires |
| Time to detect | Approx. 1-2 seconds |
| Detection range | 1-20 m depending on target type, |
| | concentration, and operation conditions |
| Size | Est. 6″ wide × 5″ high × 12″ long |
| Weight | Est. <10 lbs |
| Power required | 100 watts |
| Maturity | TRL 3 |
| Safety issues | None, passive sensor, eye safe, radiation safe |

TABLE 3

| Operational | |
|---|---|
| Features | Key Technology Solutions and Benefits |
| Sensing modality: | Short wave infrared (900-1700 nm @ 8 nm bandpass) |
| | hyperspectral imaging spectroscopy |
| Sensor operation: | Solar radiation, or external lighting flood illuminate |
| | surface; photons absorbed or reflected by materials |
| | depending on their composition. Reflected photons |
| | collected by lens and SWIR hyperspectral image |
| | modulated by multi-conjugate filter coupled to |
| | uncooled InGaAs focal plane array detector. Spatially |
| | resolved SWIR spectral signatures are compared to a |
| | SWIR-spectral library that is compiled from known |
| | material signatures, and trained against ambient |
| | background. Positive detection obtained by comparing |
| | SWIR scene to signature library using pattern |
| | matching algorithms. |
| Types of targets: | Chemicals and Explosives on Surfaces |
| | (metal, sand, concrete, skin etc.) |
| Time to Detect: | seconds |
| Detection range: | 20 m (Target Type; Concentration & CONOPS |
| | Dependent) |
| Size: | Est. 6″wide × 5″ high × 10″ long |
| Weight: | Est. <3 lbs |
| Power required: | 100 W |
| Maturity: | TRL |
| Safety issues: | None; Passive Sensor; Eye safe; Radiation safe. |

Although the disclosure is described using illustrative embodiments provided herein, it should be understood that the principles of the disclosure are not limited thereto and may include modification thereto and permutations thereof. These modifications may include but are not limited to extending this type of detection to other spectroscopic modalities including fluorescence, Raman, infrared, visible, and ultra violet.

What is claimed is:

1. A portable device comprising:
a collection optics for collecting a plurality of interacted photons, wherein said plurality of interacted photons are generated by illuminating at least a portion of a target;
a short wave infrared multi-conjugate tunable filter, configured so as to sequentially filter said plurality of interacted photons into a plurality of predetermined wavelength bands;
a first detector, wherein said first detector is configured so as to detect said plurality of interacted photons and generate at least one short wave infrared hyperspectral image representative of said target; and
a display for displaying said short wave infrared hyperspectral image.

2. The device of claim 1 further comprising a means for analyzing said short wave infrared hyperspectral image to thereby determine at least one of: the presence of a hazardous agent on said target and the absence of a hazardous agent on said target.

3. The device of claim 2 wherein said hazardous agent comprises an explosive agent.

4. The device of claim 2 wherein said hazardous agent comprises at least one of: a biological agent, a chemical agent, and combinations thereof.

5. The device of claim 1 wherein said short wave infrared multi-conjugate tunable filter comprises an integrated filter.

6. The device of claim 5 wherein said integrated filter is configured with a trigger mechanism so as to operably communicate with at least one of: said first detector, said collection optics, and combinations thereof.

7. The device of claim 1 further comprising a second detector, wherein said second detector is configured so as to generate a RGB image representative of at least one of: said target, a region of interest on said target, a sample scene comprising said target, and combinations thereof.

8. The device of claim 7 wherein said second detector comprises a CMOS RGB detector.

9. The device of claim 7 wherein said RGB image comprises a video image.

10. The device of claim 1 further comprising a power source.

11. The device of claim 10 wherein said power source comprises at least one battery.

12. The device of claim 1 further comprising at least one embedded processor.

13. The device of claim 1 further comprising an illumination source wherein said illumination source illuminates said target to thereby generate said plurality of interacted photons.

14. The device of claim 1 further comprising a means for comparing said short wave infrared hyperspectral image to at least one reference short wave infrared hyperspectral image, wherein said reference short wave infrared hyperspectral image corresponds to a known material.

15. The device of claim 1 further comprising at least one control for controlling operation of said device.

16. The device of claim 1 wherein said short wave infrared multi-conjugate tunable filter is configured with a square aperture.

17. The device of claim 1 wherein said portable device comprises a handheld device.

18. The device of claim 1 wherein said device is configured so as to operate using solar radiation as an illumination source.

19. The device of claim 1 further comprising an active illumination source configured so as to illuminate at least a portion of said target to thereby generate a plurality of interacted photons.

20. The device of claim 1 wherein said first detector comprises a focal plane array detector.

21. The device of claim 1 wherein said first detector comprises at least one of: an InGaAs focal plane array detector, an InSb focal plane array detector, a MCT focal plane array detector, and combinations thereof.

22. The device of claim 1 wherein said device is configured for dynamic imaging.

23. The device of claim 1 wherein said device is mounted onto a moving vehicle.

24. The device of claim 1 wherein said device is configured for standoff detection.

25. The device of claim 7 wherein said display is configured so as to display said short wave infrared hyperspectral image and said RGB image simultaneously.

26. The device of claim 7 wherein said display is configured so as to display said short wave infrared hyperspectral image and said RGB image sequentially.

27. A method comprising:
collecting a plurality of interacted photons using a portable device, wherein said interacted photons are generated by illuminating at least a portion of a target;
filtering said plurality of interacted photons wherein said filtering is achieved by passing said plurality of interacted photons through a short wave infrared multi-conjugate tunable filter;
detecting said plurality of interacted photons using said portable device to thereby generate at least one short wave infrared hyperspectral image representative of said target; and
analyzing said short wave infrared hyperspectral image to thereby determine at least one of: the presence of a hazardous agent and the absence of a hazardous agent.

28. The method of claim 27 wherein said collecting, filtering, detecting, and analyzing are achieved using the same portable device.

29. The method of claim 27 further comprising:
generating an RGB image representative of a sample scene using said portable device;
analyzing said RGB image to thereby identify an area of interest wherein said area of interest comprises said target.

30. The method of claim 29 further comprising selecting said area of interest based on at least one of said: size, shape, color, and combinations thereof.

31. The method of claim 27 further comprising displaying said short wave infrared hyperspectral image wherein said displaying is such that said short wave infrared hyperspectral image may be inspected by a user.

32. The method of claim 31 wherein said displaying further comprises associating at least one of the presence of a hazardous agent and the absence of a hazardous agent with a pseudo color.

33. The method of claim 27 further comprising generating at least one RGB image representative of said target.

34. The method of claim 33 wherein said RGB image comprises a RGB video image.

35. The method of claim 33 further comprising displaying said RGB image and said short wave infrared hyperspectral image simultaneously.

36. The method of claim 33 further comprising displaying said RGB image and said short wave infrared hyperspectral image consecutively.

37. The method of claim 27 wherein said hazardous agent comprise an explosive agent.

38. The method of claim 27 wherein said hazardous agent comprises at least one of: a biological agent, a chemical agent, and combinations thereof.

39. The method of claim 27 wherein said short wave infrared multi-conjugate filter comprises an integrated filter.

40. The method of claim 39 further comprising configuring said integrated filter with a trigger mechanism to provide for operable communication between said filter and at least one of: said first detector, said collection optics, and combinations thereof.

41. The method of claim 27 further comprising configuring said short wave infrared multi-conjugate filter with a square aperture.

42. The method of claim 27 wherein illuminating is achieved using an illumination source selected from the group consisting of: an active illumination source, a passive illumination source and combinations thereof.

43. The method of claim 42 wherein said passive illumination source comprises a solar illumination source.

44. The method of claim 27 wherein said analyzing further comprises comparing said short wave infrared hyperspectral image with at least one reference hyperspectral image.

45. The method of claim 44 wherein said comparing is achieved using a chemometric technique.

46. A portable device comprising:
a collection optics for collecting a plurality of interacted photons, wherein said interacted photons are generated by illuminating at least a portion of a target;
a tunable filter, configured so as to sequentially filter said plurality of interacted photons into a plurality of predetermined wavelength bands;
a first detector, wherein said first detector is configured so as to detect said plurality of interacted photons and generate a least one short wave infrared hyperspectral image representative of said target; and
a display for displaying said short wave infrared hyperspectral image.
